(19) United States
(12) Patent Application Publication
(10) Pub. No.: US 2004/0110115 A1
(43) Pub. Date: Jun. 10, 2004

(54) Time-out mat for children

(76) Inventor: Lisa B. Carvajal, Miramar, FL (US)

Correspondence Address: Caroline Nash, Nash & Titus, LLC, 3415 Brookeville Road, Brookeville, MD, 20833, US

(21) Appl. No.: 10/699,310

(22) Filed: Oct. 31, 2003

Related U.S. Application Data
(60) Provisional application No. 60/430,870, filed on Dec. 4, 2002.

(51) Int. Cl. G09B 19/00

(52) U.S. Cl. 434/237

(57) ABSTRACT

The present invention relates to a time-out mat that is used for disciplining a small child. The mat is a circular or other shaped flat device of about 20 inches in diameter that is comfortable for a young child to sit on. The mat can be constructed so that it can be folded or rolled for portability. It is useful to parents, teachers, preschool instructors, or daycare operators. A child associates that mat with discipline and it can be placed in a location where the child's behavior can be observed.

Priority is claimed to U.S. provisional application serial No. 60/430,870 filed Dec. 4, 2002.

### BACKGROUND OF THE INVENTION

1. Field of the Invention

The invention relates to a time-out mat for use with children. The mat is useful for a child to sit on when a disciplinary action is required.

2. Background of the Invention

There are numerous ways to discipline a child. Physical force has become less popular in recent years and is thought by some experts to cause emotional problems children. Parents of small children need a way to discipline their children without the use of force. Sending a child to his or her room is often a popular method. However, the “sending to your room” method places the child out of the parents' sight and is not a method that is useful when the parent and child are away from home.

The present invention relates to a time out mat that a child is told to sit on. The mat permits a child to reflect on the activity that is being punished in a quiet non violent way. The parent can observe the child during this time out period and determine the required length of time for the time out. In the past, parents have used chairs for this purpose. However, a chair is not portable and does not convey the same meaning to a child as a designated time-out mat that is used for no purpose other than for discipline.

It is also an object of the present invention to provide a designated time-out mat that is useful for disciplining young children.

It another object of the invention to provide a portable method of discipline in the form of a time out mat.

It is still another object of the present invention to provide a time-out mat that can be used as a development tool on a day to day basis.

These and other objects of the invention will be apparent to those skilled in the art from the following detailed description of the invention, the accompanying drawings and the appended claims.

### FIGURE DESCRIPTION

FIG. 1 is a top view of a time-out mat according to the present invention:

FIG. 2 is a top view of a time-out mat according to another embodiment of the invention showing the fold lines;

FIG. 3 is a side view of the present invention.

### SUMMARY OF THE INVENTION

The present invention relates to a portable time-out mat that is used for disciplining a young child. The mat is a circular or other shaped flat device of about 20 inches in diameter that is comfortable for a small child to sit on. The mat can be constructed so that it can be folded, rolled into a tube or rolled into a ball for portability. It is useful to parents, teachers, preschool instructors, or daycare operators. A child associates that mat with discipline and it can be placed in a location where the child's behavior can be observed.

### DETAILED DESCRIPTION OF THE INVENTION

The present invention is directed to a disciplinary mat or, in other words, a time-out mat.

The mat is generally circular in shape and the appropriate size for a small child to sit on. It can be provided in different sizes and shapes depending on the age of the child. A suitable size for most children is approximately 20 inches in diameter. However, a mat of up to 36 inches or larger is possible. The mat is useful for most children between the age of 2 and 9 years old.

The time-out mat is constructed out of any material that is soft and light weight. Ideally, the mat is made out of rubber such as TBD. Other types of rubber are also possible. Additionally, the time-out mat can be made out of cotton fabric, synthetic fabric, plastic or other fabrics or composites, hardened foams, soft foams, cotton or polyester loft, stuffed casings with zipper closures, etc. The preferred material is a fabric coated rubber material of approximately 0.25 to 0.0625 inches thick. The most preferred thickness is about 0.0625 inches thick. The thickness of the pad can range from the thickness of a single piece of plastic or rubber sheet to several inches thick.

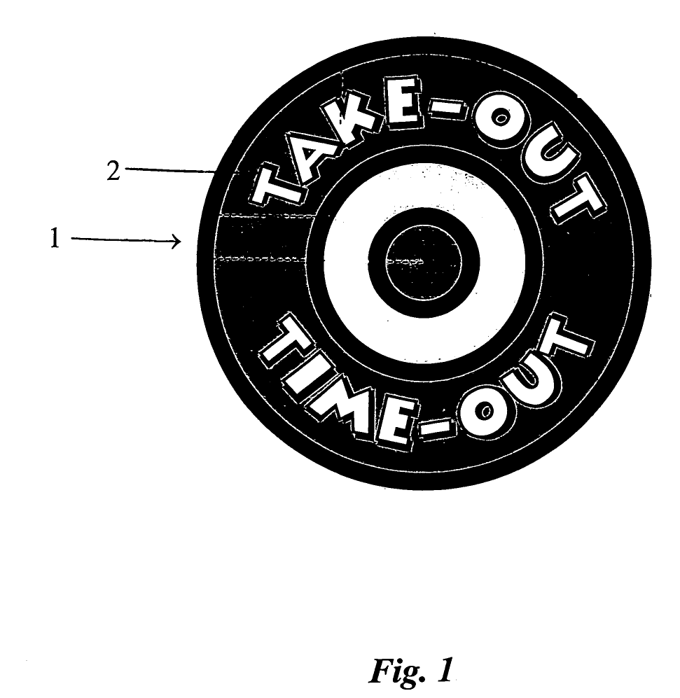

The time-out mat 1, as shown in FIG. 1 can also be made in shapes other than circular such as square, rectangular, oblong, animal shape, etc. A decorative feature 2 or logo or colors can be used to enhance the outward appearance of the mat. The alphabet, numbers, biblical characters, historical characters, animals, shapes, colors, words, symbols, cartoon characters, digital impressions, photographic impressions, pictures, or other learning indicia can be used as ornamental detail on the upper surface of the mat as a learning tool for the child to study during a time out period.

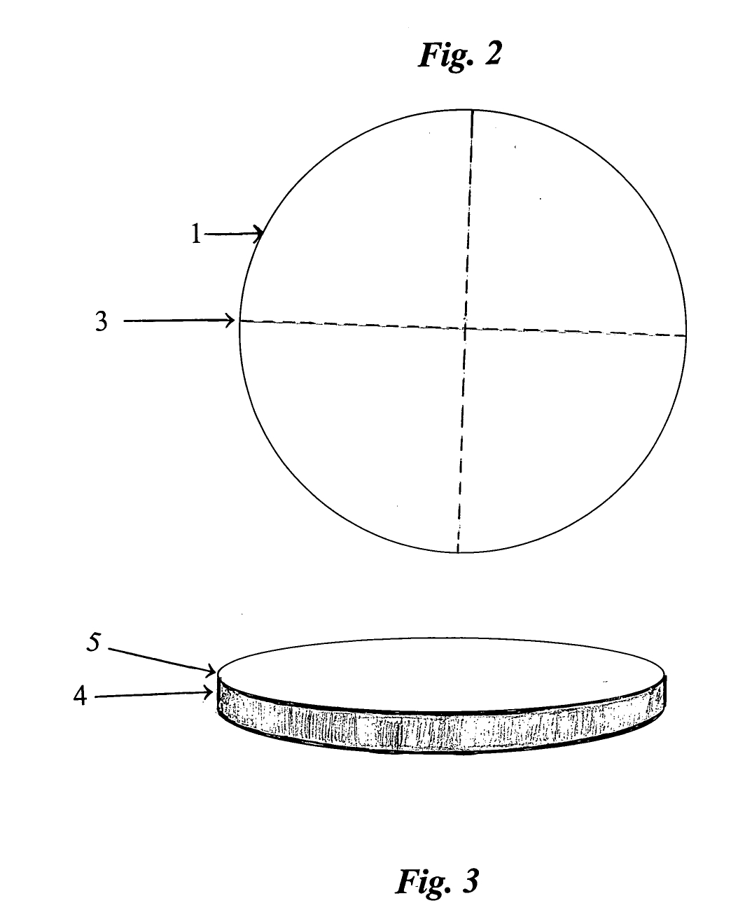

A time-out mat is manufactured so that it is flexible enough to be rolled, folded, or shaped like a ball for portability. In one embodiment, it can be folded for portability as shown in FIG. 2. In the case of a circular time-out mat, the mat can be cut into three or more wedges and than sewed together. The time-out mat is then foldable along the seams 3 and can be carried. This seam/fold structure can also be accomplished with other shapes. The time out mat can also be a single piece of material and be with or without crease marks for folding or rolling.

In the case of a mat that is to be rolled up into a ball during storage or transport, the material that is used is chosen to be resilient and with enough elasticity to be re-shaped into a flat mat with ease.

FIG. 3 shows a side view of the construction of the time out mat according to a preferred embodiment (not to scale). A rubber material 4 is coated with an upper fabric layer 5 is shown.

A carrying case can also be provided such as a bag or case. Disposable or washable slip covers can also be provided for convenience.

For the method of the invention, the time-out mat is placed in a suitable location chosen by the parent or teacher. A child is placed on the time-out mat for discipline when he or she is engaging in an activity that is not permitted. The parent or teacher chooses the appropriate time period for the time out depending on the circumstances of the infraction and the age or nature of the child. The child associates that mat with discipline. Since the mat is made out of a material that is soft, the child can not injure himself with the time-out mat and cannot fall off the time-out mat because it is placed on the floor.

The method of the present invention is not limited to the examples recited herein. Having thus described in detail preferred embodiments of the invention, it is to be understood that the invention defined by the appended claims in not to be limited by particular details set forth in the above description as many apparent variations thereof are possible without departing from the spirit or scope of the present invention.

What is claimed is:

1. A portable time-out device comprising: a shaped sitting mat that is used for disciplining a small child, said mat comprising a soft material for placing on the ground and being flexible for folding, rolling or balling up of said mat.

2. The portable time-out device of claim 1, wherein said shaped sitting mat is circular, square, rectangular, or oblong.

3. The portable time-out device of claim 2, wherein said circular shape has seams for folding the mat along the seams for ease in transporting the mat.

4. The portable time-out device of claim 1, further comprising decorative or educational indicia or ornamentation on an upper surface thereof.

5. The portable time-out device of claim 1, wherein the material comprises rubber, plastic, cotton loft, polyester loft, or fabric composites.

6. The portable time-out device of claim 1, wherein the mat is circular and has a diameter of 20-36 inches.

7. The portable time-out device of claim 1, wherein said mat has a thickness of about 0.0625 to about 0.25 inches.

8. The portable time-out device of claim 1, wherein said material is rubber and said rubber has a fabric surface.

9. The portable time-out device of claim 1, wherein said mat is in the shape of an animal.

10. The portable time-out device of claim 1, wherein said mat is in the shape of a cartoon character.

11. The portable time-out device of claim 1, wherein said mat has an upper surface and said upper surface has decorative indicia comprising one or more of letters, numbers, shape characters, colors, words, symbols, cartoon characters, biblical characters, digital impressions, photographic impressions or pictures.

12. The portable time-out device of claim 1, further comprising a carrying container.

13. The portable time-out device of claim 12, wherein said carrying container is a bag.

14. The portable time-out device of claim 1, further comprising a disposable slip cover.

15. The portable time-out device of claim 1, further comprising a washable slip cover.

16. The portable time-out device of claim 1, wherein said material is TBD.

17. The portable time-out device of claim 1, wherein said material is cotton fabric, plastic, synthetic fabric, composites, hardened foams, soft foam, cotton or polyester loft.

18. The portable time-out device of claim 1, wherein said material is a stuffed casing with a zipper closure.

19. A portable time-out device comprising a sitting mat that is used for disciplining a small child, said mat comprising a flat piece of rubber having an upper fabric coating and said mat being flexible for folding, rolling or balling up for transport of storage.

20. The portable time-out device of claim 19, wherein said mat is about 0.06 to 0.25 inches thick
